(19) United States
(12) Patent Application Publication
(10) Pub. No.: US 2021/0188725 A1
(43) Pub. Date: Jun. 24, 2021

(54) COMPOSITION COMPRISING NITROGEN AND A SELENIUM-ENRICHED YEAST AND METHOD FOR INCREASING THE CONTENT OF SELENIUM IN PLANTS BY APPLYING THE COMPOSITION TO SOILS

(71) Applicant: DANSTAR FERMENT AG, Zug (CH)

(72) Inventors: Olivier Cor, Saint Jean de Boiseau (FR); Jean-Marc Sanchez, Daux (FR)

(73) Assignee: DANSTAR FERMENT AG, Zug (CH)

(21) Appl. No.: 17/055,401

(22) PCT Filed: May 15, 2019
(86) PCT No.: PCT/EP2019/062532

§ 371 Date: Nov. 13, 2020

(30) Foreign Application Priority Data
May 15, 2018 (EP) 18290052.2

(51) Int. Cl. C05D 9/02; A01N 63/32; A01N 59/02; C05F 11/08

(52) U.S. Cl. CPC C05D 9/02; C05F 11/08; A01N 59/02; A01N 63/32

(57) ABSTRACT

The present disclosure concerns a new method of increasing the selenium content of plants by a soil application of a selenium-enriched yeast and at least one nitrogen source.

### TECHNOLOGICAL FIELD

The present disclosure relates to a method of increasing the selenium content of plants by treating a soil environment with a selenium-enriched yeast in combination with at least one nitrogen source.

### BACKGROUND

Selenium is an essential element in the lives of animals and humans. All cells in the body contain selenium in concentrations that vary from one tissue to another and are related to the content in the food ingested. Insufficient intake of selenium in foods leads to very frequent deficiencies in certain areas of the world which lead to the development of human diseases such as cardiovascular diseases and cancer. Although, selenium performs in variety of functions, its antioxidant, immunostimulant roles and anticancerous properties are of primary interest. Due to the health benefits and adverse effects of selenium deficiency, foods and dietary supplements are often supplemented with selenium.

There are various forms of selenium that are more or less toxic. Inorganic forms, mainly selenium salts (selenites or selenates such as sodium selenite or sodium selenate), must be handled with care because of their toxicity. Organic forms are much less toxic, such as selenomethionine, which corresponds to the naturally occurring form in yeasts, which could be related to the fact that methionine also provides the methyl groups necessary for the detoxification of selenium. Selenites and seleniates are used for medical purposes and for the supplementation of food rations. Selenomethionine and selenium-enriched yeasts are also used today to supplement dietary rations.

In agriculture, to allow selenium-enriched herd feed ratios, several selenium-enriched fertilizers have been marketed. The fertilizers contain selenium salts (selenites or seleniates) that will be absorbed and metabolized by the plant after application. The plants being enriched in selenium, the food ration can therefore be indirectly enriched in selenium in an organic form which is highly assimilable.

D1 describes a method of cultivating a selenium-rich Cyclocarya paliurus plant, comprising use of a selenium-rich organic fertilizer, wherein the selenium-rich organic fertilizer comprises a selenium-rich yeast, a humic acid, an amino acid, a plant growth regulator and a foliar penetration enhancer.

D2 discloses a bioorganic compound coated fertilizer comprising hoof and horn powder, bone powder, pork skin powder, ammonium molybate, borax, zinc sulfate, silicon fertilizer, lignosulfonate, ferric oxide, urea-formadelhyde resin (water-soluble), starch, tallow amine, polyoxyethylene ether, diammonium phosphate, potassium persulfate, agent comprising effective microorganisms, soil improving agent and water.

D3 describes a process for the treatment of vegetable and/or fruit crop plants in order to enrich them with selenium, characterized in that the selenium supply is carried out in the form of inactive yeast and/or yeast derivatives by foliar application.

There is an increasing interest to date in selenium-enrichment of fruits and vegetables using non-toxic fertilizers (as, for example, selenium-enriched yeasts) via a foliar application. Indeed, selenium salts are too toxic for foliar applications. However, it is known that foliar application of selenium is better and efficient means of selenium biofortification than application of selenium fertilizers in soil, due to avoidance of root to shoot translocation of selenium (Winkel et al., 2015). It has been demonstrated that the use of selenium fertilizers in soil have low rates of selenium enrichment in edible part of plant, moreover, long term use can be toxic to nearby ecosystem, hence use of selenium fertilizers should be done carefully to avoid toxic aspects (Winkel et al., 2015). There is thus a need to provide further methods and combinations for altering the property and nature of plants in order to produce selenium-enriched plants while preserving the soil environment against selenium toxicity.

### BRIEF SUMMARY

The present disclosure relates to a new method of reducing the amount of selenium in the environment while maintaining a similar effect on selenium enrichment of a plant.

In a first aspect, the present disclosure concerns a method for increasing the selenium content of a plant comprising simultaneously, sequentially or separately inoculating a soil environment with an effective amount:
(a) of selenium supplied by a selenium-enriched yeast; and
(b) at least one nitrogen source;
   in an (a)/(b) weight ratio of 1:1000 to 1:70 000;
   thereby producing selenium-enriched plants with an increased internal concentration of selenium in comparison to the selenium content of selenium-enriched plants treated with a selenium-enriched yeast alone. In an embodiment, said selenium-enriched plants contain an internal concentration of selenium similar or higher than selenium-enriched plants produced when inorganic selenium are used alone or in combination with at least one nitrogen source. In yet another embodiment, the amount of selenium supplied by the selenium-enriched yeast required for increasing the selenium content of said plant is at least 10%, 15%, 20%, 25%, 30%, 35%, 40%, 45%, 50%, 55%, 60%, 65%, 70% or 75% smaller than the amount required to achieve the same selenium content of said plant when inorganic selenium is used alone or in combination with at least one nitrogen source. In still another embodiment, the selenium-enriched yeast can be an active selenium-enriched yeast, an inactivated selenium-enriched yeast, a selenium-enriched yeast extract, a selenium-enriched yeast autolysate, selenium-enriched yeast cell walls, selenium-enriched yeast derivatives or combinations thereof. In yet a further embodiment, the selenium-enriched yeast is an inactivated selenium-enriched yeast and/or selenium-enriched yeast derivatives. In an embodiment, the selenium-enriched yeast can be a Saccharomyces and can belong to the species S. cerevisiae or S. cerevisiae var. boulardii. In another embodiment, the selenium-enriched yeast can be a non-Saccharomyces yeast and can belong to the genera Candida, Torula, Hanseniaspora, Hansenula, Kluyveromyces, Metschnikowia, Pichia, Starmerella, Torulaspora or mixture thereof. In yet another embodiment, the amount of selenium supplied by the selenium-enriched yeast can be between 500 to 10 000 ppm and the amount of selenium supplied by the selenium-enriched yeast can be, for example, at least about 2000 ppm, 3000 ppm, 4000 ppm, 5000 ppm, 6000 ppm, 7000 ppm, 8000 ppm, 9000 ppm or 10 000 ppm. In still a further embodiment, the at least one nitrogen source can be urea, liquid urea, ammonium nitrate, ammonium anhydrous, calcium nitrate, potassium nitrate, ammonium sulfate, ammonium thiosulphate, ammonium phosphate, liquid ammonium polyphosphate, ammonium nitrate, or mixtures thereof. The (a)/(b) weight ratio will vary depending on the particular selenium-enriched yeast (for example according to level of enrichment) and the particular nitrogen source used. The (a)/(b) weight ratio can be at least of about 1:1250; 1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500; 1:10 000; 1:10 500; 1:11 000; 1:11 500; 1:12 000; 1 to 12 500; 1:15 000; 1:17 500; 1:20 000; 1:22 500, 1:25 000, 1:30 000; 1:35 000; 1:40 000; or 1:50 000. Preferably, the (a)/(b) weight ratio is in the range of about 1:5000 to about 1:20 000. The (a)/(b) ratio may be in the range of about 1:3000 to about 1:50 000, about 1:5000 to about 1:50 000, about 1:7500 to about 50,000, about 1:9000 to about 50,000, about 1:5000 to about 1:30,000, about 1:10 000 to about 1:30,000, or about 1:10 000 to about 1:20,000. Also described is an (a)/(b) weight ratio of at least about 1:20; 1:25; 1:50; 1:100; 1:150; 1:200; 1:250; 1:300; 1:350; 1:400; 1:450; 1:500; 1:550; 1:600; 1:650; 1:700; 1:750; 1:800; 1:850; 1:900; 1:950; 1:1000; 1:1250; 1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; or 1:9500. In yet another embodiment, the selenium supplied by the selenium-enriched yeast is applied to the soil environment at a rate of about 0.05 to 20 g/ha, 0.1 to 20 g/ha, 0.5 to 20 g/ha, 1 to 15 g/ha, 1 to 10 g/ha, 2 to 10 g/ha or 2 to 5 g/ha. By “selenium supplied by a selenium-enriched yeast”, reference is made to the supplied selenium being comprised within a yeast prior to its supply to the soil environment, the yeast thus being selenium-enriched. The level of enrichment of the selenium-enriched yeast represents the selenium content and thus the amount of selenium available for supply by the selenium-enriched yeast. By “at least one nitrogen source”, reference is made to a compound or mixture of compounds supplying nitrogen, such as nitrogen in the form of urea, nitrate ions, and/or ammonia ions, with the weight ratio of (a) to (b) referring to the ratio of selenium supplied by the selenium-enriched yeast to that of nitrogen supplied by the nitrogen source.

In a second aspect, the present disclosure relates to a composition for increasing the selenium content of a plant comprising:
(a) selenium supplied by a selenium-enriched yeast; and
(b) at least one nitrogen source
   in an (a)/(b) weight ratio in the range of 1:1000 to 1:70 000;
   wherein said composition is effective to produce selenium-enriched plants with an increased internal concentration of selenium in comparison to the selenium content of selenium-enriched plants treated with a selenium-enriched yeast alone. In an embodiment, the selenium-enriched yeast can be an active selenium-enriched yeast, an inactivated selenium-enriched yeast, a selenium-enriched yeast extract, a selenium-enriched yeast autolysate, selenium-enriched yeast cell walls, selenium-enriched yeast derivatives or combinations thereof. In a further embodiment, the selenium-enriched yeast is an inactivated selenium-enriched yeast and/or selenium-enriched yeast derivatives. In still another embodiment, the selenium-enriched yeast is a Saccharomyces and can belong to the species S. cerevisiae or S. cerevisiae var. boulardii. In yet another embodiment, the selenium-enriched yeast can be a non-Saccharomyces yeast and can belong to the genera Candida, Torula, Hanseniaspora, Hansenula, Kluyveromyces, Metschnikowia, Pichia, Starmerella, Torulaspora or mixture thereof. In yet another embodiment, the amount of selenium supplied by the selenium-enriched yeast is between 500 to 10 000 ppm and can be, for example, at least about 2000 ppm, 3000 ppm, 4000 ppm, 5000 ppm, 6000 ppm, 7000 ppm, 8000 ppm, 9000 ppm or 10 000 ppm. In still another embodiment, the nitrogen source can be urea, liquid urea ammonium nitrate, ammonium anhydrous, calcium nitrate, potassium nitrate, ammonium sulfate, ammonium thiosulphate, ammonium phosphate, liquid ammonium polyphosphate, ammonium nitrate, or mixtures thereof. The selection of amounts of selenium supplied by a selenium enriched yeast and of a nitrogen source for the composition are as described above in relation to the method for increasing the selenium content of a plant of the present disclosure. Thus, for example the (a)/(b) weight ratio can be at least of about 1:1250; 1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500; 1:10 000; 1:10 500; 1:11 000; 1:11 500; 1:12 000; 1 to 12 500; 1:15 000; 1:17 500; 1:20 000; 1:22 500, 1:25 000, 1:30 000; 1:35 000; 1:40 000; or 1:50 000. Preferably, the (a)/(b) weight ratio is in the range of about 1:5000 to about 1:20 000. The (a)/(b) ratio may be in the range of about 1:3000 to about 1:50 000, about 1:5000 to about 1:50 000, about 1:7500 to about 50,000, about 1:9000 to about 50,000, about 1:5000 to about 1:30,000, about 1:10 000 to about 1:30,000, or about 1:10 000 to about 1:20,000. Also described is an (a)/(b) weight ratio of at least of about 1:20; 1:25; 1:50; 1:100; 1:150; 1:200; 1:250; 1:300; 1:350; 1:400; 1:450; 1:500; 1:550; 1:600; 1:650; 1:700; 1:750; 1:800; 1:850; 1:900; 1:950; 1:1000; 1:1250; 1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500. In still another embodiment, the selenium supplied by the selenium-enriched yeast is applied to the soil environment at a rate of about 0.05 to 20 g/ha, 0.1 to 20 g/ha, 0.5 to 20 g/ha, 1 to 15 g/ha, 1 to 10 g/ha, 2 to 10 g/ha or 2 to 5 g/ha.

The present disclosure also provides a method of fertilising a soil environment comprising inoculating said soil environment with a composition of the present disclosure, or simultaneously, sequentially or separately inoculating a soil environment with an effective amount of (a) selenium supplied by a selenium-enriched yeast; and (b) at least one nitrogen source, in an (a)/(b) weight ratio of 1:1000 to 1:70 000; wherein said effective amount is capable of producing selenium-enriched plants with an increased internal concentration of selenium in comparison to the selenium content of selenium-enriched plants treated with a selenium-enriched yeast alone.

The present disclosure further provides use of at least one nitrogen source for increasing selenium uptake in a plant or seed from a selenium-enriched yeast.

The selenium-enriched yeast and nitrogen source used in the method of fertilising a soil environment or use for increasing selenium uptake (and their ratio) are as generally described above in relation to the method for increasing the selenium content of a plant of the present disclosure.

### FIGURE

Having thus generally described the nature of the invention, reference will now be made to the accompanying drawings, showing by way of illustration, a preferred embodiment thereof, and in which:

FIG. 1 shows the total amount of selenium in aerial parts of the plants for each treatment (ppm). T1: untreated; T2: nitrogen; T3: nitrogen+sodium selenate; T4: nitrogen+selenium-enriched yeast; T5: selenium-enriched yeast; T6: sodium selenate. A two-way analysis of variance (ANOVA) was performed between column terms and online terms. Grey: significant difference at the alpha threshold of 5%; dotted box: significant difference at the alpha threshold of 10%; white: no significant difference at the alpha threshold of 10%.

### DETAILED DESCRIPTION

It has been surprisingly discovered that a soil application of a selenium-enriched yeast in combination with at least one nitrogen source, simultaneously, sequentially or separately from each other, produce selenium-enriched plants with an increased internal concentration of selenium compared to plants treated with a selenium-enriched yeast alone. Results have demonstrated that the nitrogen source has a synergistic effect on the effectiveness of the selenium-enriched yeast. The combination of a selenium-enriched yeast with at least one nitrogen source allows an effective translocation of the selenium contained in the selenium-enriched yeast from the roots to shoots. Moreover, the amount of selenium metal supplied by the selenium-enriched yeast used is lower than the amount of selenium metal required to achieve the same plant enrichment when inorganic selenium salts are used. Indeed, the resultant selenium-enriched plants contain an internal concentration of selenium similar or higher than selenium-enriched plants produced when inorganic selenium salts are used alone or in combination with at least one nitrogen source at a higher concentration of selenium metal. In other words, the use of a selenium-enriched yeast in combination with at least one nitrogen source make it possible to reduce the dose of selenium metal while preserving an equivalent enrichment effect. Thus, the environment is favoured as the total amount of selenium concentration applied to a soil for a certain enrichment effect to be obtained is lowered. Therefore, the combination of a selenium-enriched yeast with at least one nitrogen source allows to reduce the total amount of active compounds (i.e. selenium) applied which results in a decreased amount of residues in the soil environment.

To this end, the present disclosure provides a method for increasing the selenium content of a plant by treating or inoculating a soil environment with a selenium-enriched yeast in combination with at least one nitrogen source, simultaneously, sequentially or separately from each other. Delivery of the combination of a selenium-enriched yeast and at least one nitrogen source to a soil environment provides crop plants enriched in selenium, said crop plants being intended for human or animal food. Another embodiment of the present disclosure is to provide food supplements enriched with selenium for human or animal food.

Thus, the plant may be a leguminous plant, a grass, a cereal, a vegetable, a fruit crop or a food crop. The plant may be an animal food crop, such as a forage crop, a cereal, maize, a leguminous plant, or an oil and/or protein-rich plant or vegetable crop. In some embodiments, the plant is not a tree, not a tree producing a fruit crop, or is not the tree Cyclocarya Paliurus.

The present disclosure also provides a combination of components for increasing the selenium content of a plant comprising a selenium-enriched yeast and/or a selenium-enriched yeast derivatives and at least one nitrogen source wherein said selenium-enriched yeast and/or a selenium-enriched yeast derivatives or at least one nitrogen source are present in a form that can be delivered simultaneously, sequentially or separately from each other to a soil environment of a plant. By the term “combination” as used herein, the term means two or more substances in proximity to one another and/or used together, regardless of whether a carrier is included. The composition of a selenium-enriched yeast and/or a selenium-enriched yeast derivatives and the at least one nitrogen source may be considered a combination. In some embodiments, such a composition does not include all of a humic acid, an amino acid, a plant growth regulator and a foliar penetration enhancer, or does not include a foliar penetration enhancer. The nitrogen source used according to the invention is typically an inorganic nitrogen source or may be in an organic form as urea.

In another embodiment, the present disclosure provides a composition for increasing the selenium content of a plant comprising a selenium-enriched yeast (i.e. selenium supplied by a selenium-enriched yeast) and/or a selenium-enriched yeast derivatives and at least one nitrogen source.

The bio-stimulant combination of a selenium-enriched yeast with at least one nitrogen source as described herein can be used, as previously mentioned, not only to increase the selenium content of a plant but also to achieve more efficient nutrient utilization.

As used herein, the term “delivering simultaneously” means that a selenium-enriched yeast with at least one nitrogen source are delivered to a soil environment of a plant at the same time or substantially at the same time via the same mode of application.

As used herein, the term “delivering separately” means that a selenium-enriched yeast with at least one nitrogen source are delivered to a soil environment of a plant at the same time or substantially at the same time via a different mode of application.

As used herein, the term “delivering sequentially” means that a selenium-enriched yeast with at least one nitrogen source are delivered to a soil environment of a plant at different times, the mode of application being identical or different.

The production of selenium-enriched yeast is well known to those skilled in the art who know how to prepare it by means of one of the techniques at their disposal. A selenium-enriched yeast is produced by growing yeasts on culture media highly concentrated in selenium. Live yeasts absorb and metabolize selenium to selenomethionine and other selenoproteins. The intracellular selenium metal content of yeast is in the range of 500 to 10 000 ppm. For example, the selenium metal content may be greater than 500 ppm, 600 ppm, 700 ppm, 800 ppm, 900 ppm, 1000 ppm, 1100 ppm, 1200 ppm, 1300 ppm, 1400 ppm, 1500 ppm, 1600 ppm, 1700 ppm, 1800 ppm, 1900 ppm, 2000 ppm, 2100 ppm, 2200 ppm, 2300 ppm, 2400 ppm, 2500 ppm, 2600 ppm, 2700 ppm, 2800 ppm, 2900 ppm, 3000, 3100 ppm, 3200 ppm, 3300 ppm, 3400 ppm, 3500 ppm, 3600 ppm, 3700 ppm, 3800 ppm, 3900 ppm, 4000 ppm, 4100 ppm, 4200 ppm, 4300 ppm, 4400 ppm, 4500 ppm, 4600 ppm, 4700 ppm, 4800 ppm, 4900 ppm, 5000 ppm, 5100 ppm, 5200 ppm, 5300 ppm, 5400 ppm, 5500 ppm, 5600 ppm, 5700 ppm, 5800 ppm, 5900 ppm, 6000 ppm, 6100 ppm, 6200 ppm, 6300 ppm, 6400 ppm, 6500 ppm, 6600 ppm, 6700 ppm, 6800 ppm, 6900 ppm, 7000 ppm, 7100 ppm, 7200 ppm, 7300 ppm, 7400 ppm, 7500 ppm, 7600 ppm, 7700 ppm, 7800 ppm, 7900 ppm, 8000 ppm, 8100 ppm, 8200 ppm, 8300 ppm, 8400 ppm, 8500 ppm, 8600 ppm, 8700 ppm, 8800 ppm, 8900 ppm, 9000 ppm, 9100 ppm, 9200 ppm, 9300 ppm, 9400 ppm, 9500 ppm, 9600 ppm, 9700 ppm, 9800 ppm, 9900 ppm or 10 000 ppm. In yeast not enriched in selenium (non-selenium yeast) the selenium content is very low of the order of a few ppm. In the method according to the present disclosure, said selenium-enriched yeast contains more than 0.05% of selenium metal by weight relative to the weight of solids of the yeast. Advantageously, said selenium-enriched yeast contains at least 0.01% of selenium metal, at least 0.1% of selenium, at least 0.2% of selenium, at least 0.3% of selenium, at least 0.4% of selenium, at least 0.5% of selenium, at least 0.6% of selenium, at least 0.7% of selenium, at least 0.8% of selenium, at least 0.9% of selenium or at least 1% of selenium by weight relative to the weight of solids of the yeast. As an example, a selenium-enriched yeast is commercially available under the trademark Alkosel® (available from Lallemand).

The selenium-enriched yeast can be applied to the soil environment in the form of inactive dry yeast, but also in the form of active dry yeast. There is in fact nothing to stop the user carrying out several introductions of enriched yeast, taken in different forms. Alternatively, the selenium-enriched yeast can be applied to the soil environment in the form of inactive liquid yeast or active liquid yeast. The yeast composition applied to the soil environment may comprise at least one live yeast, inactivated yeast, yeast extract, yeast autolysate, yeast cell walls, any other whole yeast derivatives obtained by physico-chemical and/or enzymatic treatment, or any combination of the above. The physico-chemical treatment may comprise a temperature and/or pH treatment. In an embodiment, the yeast composition comprises a yeast extract. The various processes and suitable conditions for preparing the different yeast compositions are known to the person skilled in the art. Preferably, the selenium-enriched yeast is an inactivated yeast containing high levels of organic selenium trace element in the natural L (+) selenomethionine form.

The yeast may be any suitable Saccharomyces or a non-Saccharomyces yeast as, for example, from the genera Candida, Torula, Hanseniaspora, Hansenula, Kluyveromyces, Metschnikowia, Pichia, Starmerella, Torulaspora. In an embodiment, the genera Saccharomyces includes, without limitation, S. cerevisiae or S. cerevisiae var. boulardii. In an embodiment, a single yeast strain can be used. Alternatively, two or more different yeast strains or species can be used in combination.

The nitrogen sources or nitrogenous components that can be used in conjunction with the selenium-enriched yeast, simultaneously, sequentially or separately from each other, may be from any form. Nitrogen sources may include organic nitrogen sources, inorganic nitrogen sources, or a mixture thereof. Suitable organic nitrogen source may include, but is not limited to, urea. “Inorganic nitrogen sources” are mineral-based and/or ionic compounds containing, for example, nitrate ions and/or ammonia ions, both of which provide nitrogen in a form available for uptake by plants or for conversion into an uptake which is in a compatible form by soil microorganisms. In an embodiment, the nitrogen source is a nitrate-containing, a urea-containing, an ammonium-containing compound, or mixtures thereof. In a further embodiment, the nitrogen source can be, for example, urea (as, for example, urea 46% nitrogen), liquid urea ammonium nitrate, ammonium anhydrous, calcium nitrate, potassium nitrate, ammonium sulfate, ammonium thiosulphate, ammonium phosphate, liquid ammonium polyphosphate, ammonium nitrate, related compounds or any combinations thereof. The nitrogen source/nitrogen fertilizer is applied according to crop-specific recommendations which will depend upon the application method, time of application, rate of application, and product formulation. Methods to calculate the fertilizer application rate is well known to those skilled in the art. For example, at least about 1, 2, 5 10 15, 20, 25, 30, 35, 40, 45, 50, 55, 60, 65, 70, 75, 80, 85, 90, 95, and more than 100 kg/ha of nitrogen can be used.

The composition of the present disclosure may include a suitable carrier and/or diluent and may be provided in a form of a solid, a powder, a solution, dispersion, a suspension, a paste, an aerosol or a spray, wherein the active ingredients of the present disclosure (namely, the selenium-enriched yeast and the at least one nitrogen source) are formulated in a manner which suits the specific application. Non-limiting examples of suitable, formulations are: emulsion concentrates, suspension concentrates, water dispersible granule and wettable powders. The carrier or diluent, which is an agriculturally acceptable carrier or diluent, may be any one or more of a number of carriers that confer a variety of properties, such as increased stability, wettability, dispersability, etc. Suitable carriers may include, but are not limited to, water or other aqueous solutions, slurries, solids (e.g., peat, wheat, bran, vermiculite, pasteurized soil, etc) or dry powders. The composition or formulation may include additional additives including, but not limited to, buffering agents, surfactants, adjuvants, or coating agents. The composition may also comprise, for example, a selenium-enriched yeast and a carrier or diluent along with additional biocontrol agent such as an antifungal agent or pesticide (insecticide, fungicide, nematicide, bacteriocide or herbicide).

The selenium-enriched yeast and the at least one nitrogen source of the present disclosure may be applied, delivered directly or mixed directly to soil or substrate in which the plants are growing or to be grown or in which the seeds have been or are to be sown. The application may be performed by any suitable means as, for example, spreading, spraying, or pouring soil or substrate. Soil or substrate may be treated as many times as necessary and the number of applications may be determined depending on, for example, the fertilization program, the plant species, environmental and/or climatic conditions and the purpose for which the plant is grown. Preferably, the selenium-enriched yeast and the nitrogen source are delivered simultaneously to the soil or substrate, i.e. at the same time or substantially at the same time via the same mode of application.

The delivery to the soil or substrate of the selenium-enriched yeast and at least one nitrogen source (inoculation of the soil environment) may thus be carried out prior to sowing of seeds, subsequent to sowing of seeds, or prior to growth of plants, or on seedlings. The inoculation may be carried out prior to establishment of seeds. The inoculation may be carried out in early stage development of plants, for example prior to visible growth of a plant, or to seedlings. The inoculation may be carried out up to one week, two weeks, three weeks or a month after sowing of seeds.

In an embodiment, the combination of the selenium-enriched yeast with at least one nitrogen source of the present disclosure may be applied to any types of plants. Examples of plants include, but are not limited to, cereals (such as wheat, barley, oat, rye, triticale), maize, rice, leguminous plants (such as alfalfa, clover, sainfoin), forage crop (such as ryegrass, fescues, cocksfoot, festulolium, vetch, forage turnips, forage radishes), oil- and protein-rich plants (such as soybeans, colza, peas, fava beans, white lupin, sunflower), vegetable crops, fruit trees, viticulture and ornamental crops (such as flower production, turfgrass, nurseries).

The amount of selenium supplied by the selenium-enriched yeast applied to the soil environment is an effective amount to increase the content or concentration of selenium in the plants in comparison with untreated controls. The selenium supplied by the selenium-enriched yeast or composition of the present disclosure is applied to the soil environment at a rate of about 0.05 to 20 g/ha, 0.1 to 20 g/ha, 0.5 to 20 g/ha, 1 to 15 g/ha, 1 to 10 g/ha, 2 to 10 g/ha or 2 to 5 g/ha. In an embodiment, the rate of application is at least 4 g/ha.

The selenium-enriched yeast and at least one nitrogen source of the present disclosure are used or employed in a synergistic weight ratio. A “synergistically effective amount” as used herein refers to represent a quantity of a combination of selenium-enriched yeast and at last one nitrogen source that is more effective (statistically significantly more effective) to increase the internal concentration of selenium in plants than the selenium-enriched yeast only. The skilled person is able to find out the weight ratios for the present disclosure by routine methods. The skilled person understands that these ratios refer to the ratio within a composition as well as to the calculative ratio of the amount of selenium supplied by the selenium-enriched yeast described herein and the amount of nitrogen supplied by the at least one one nitrogen source when both components are applied as a combination to a soil environment to be treated. The skilled person can calculate this ratio by simple mathematics since the volume and/or the amount of selenium supplied by the selenium-enriched yeast and the amount of nitrogen supplied by the at least one nitrogen source, respectively, in a combination is known to the skilled person.

The weight ratio of the amount of selenium supplied by the selenium-enriched yeast and the amount of nitrogen supplied by the at least one nitrogen source (namely the nitrogen application amount) lies typically in the range of 1:1000 to 1:70 000. Thus, the weight ration may be 1:1250; 1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500; 1:10 000; 1:10 500; 1:11 000; 1:11 500; 1:12 000; 1 to 12 500; 1:15 000; 1:17 500; 1:20 000; 1:22 500, 1:25 000, 1:30 000; 1:35 000; 1:40 000; or 1:50 000. In some other embodiments described herein, the weight ratio can be greater than or equal to 1:20; 1:25; 1:50; 1:75; 1:100; 1:150; 1:200; 1:250; 1:300; 1:350; 1:400; 1:450; 1:500; 1:550; 1:600; 1:650; 1:700; 1:750; 1:800; 1:850; 1:900; 1:950; 1:1000; 1:1500; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500; 1:10 000; 1:10 500; 1:11 000; 1:11 500; 1:12 000; 1:12 500; 1:13 000; 1:13 500, 1:14 000; 1:14 500; 1:15 000; 1:15 500; 1:16 000; 1:16 500; 1:17 000; 1:17 500; 1:18 000; 1:18 500; 1:19 000; 1:19 500; 1:20 000; 1:20 500; 1:21 000; 1:21 500; 1:22 000; 1:22 500; 1:23 000; 1:23 500, 1:24 000; 1:24 500; 1:25 000; 1:25 500; 1:26 000; 1:26 500; 1:27 000; 1:27 500; 1:28 000; 1:28 500; 1:29 000; 1:29 500; 1:30 000; 1:30 500; 1:31 000; 1:31 500; 1:32 000; 1:32 500; 1:33 000; 1:33 500, 1:34 000; 1:34 500; 1:35 000; 1:35 500; 1:36 000; 1:36 500; 1:37 000; 1:37 500; 1:38 000; 1:38 500; 1:39 000; 1:39 500; 1:40 000; 1:40 000; 1:40 500; 1:41 000; 1:41 500; 1:42 000; 1:42 500; 1:43 000; 1:43 500, 1:44 000; 1:44 500; 1:45 000; 1:45 500; 1:46 000; 1:46 500; 1:47 000; 1:47 500; 1:48 000; 1:48 500; 1:49 000; 1:49 500; 1:50 000; 1:55 000; 1:60 000; 1:65 000; 1:70 000; 1:75 000; 1:80 000; 1:85 000; 1:90 000, 1:90 500; 1:95 000; 1:95 500; 1:100 000.

The combination of a selenium-enriched yeast and an at least one nitrogen source of the present disclosure enables the use of relative lower amounts of selenium, particularly as compared with the amounts of selenium required to achieve the same effect with the use of inorganic selenium. The amount of selenium supplied by said selenium-enriched yeast required for increasing the selenium content of said plant is at least 10%, 15%, 20%, 25%, 30%, 35%, 40%, 45%, 50%, 55%, 60%, 65%, 70% or 75% smaller than the amount required to achieve the same selenium content of said plant when inorganic selenium (selenium salts) are used alone or in combination with at least one nitrogen source. In an embodiment, the amount of selenium supplied by said selenium-enriched yeast required for increasing the selenium content of said plant is at least 40% smaller than the amount required to achieve the same selenium content of said plant when inorganic selenium (selenium salts) are used alone or in combination with at least one nitrogen source.

The word “comprising” in the claims may be replaced by “consisting essentially of” or with “consisting of,” according to standard practice in patent law.

The following example serves to further describe and define the invention, and is not intended to limit the invention in any way.

### Example 1

Effect of selenium-enriched yeast in combination with a nitrogenous component on the internal content of selenium in plants

The increase of the selenium content in plants following a treatment with selenium-enriched yeast in combination with nitrogenous components was evaluated. The study was realized with an inactivated strain of Saccharomyces cerevisiae enriched in selenium (content of 2000 ppm of selenium which is equivalent to 2 g of selenium metal/kg of dry yeast) (Alkosel®, Lallemand). The selenium enriched yeast was added at a concentration of 2.4 kg/ha and supplied selenium at a concentration of 4.8 g/ha. Seeds of Ray Grass (var. Italien Alternatif, Vegenov) were used in the study. Ammonium sulfate (Vegenov) was used as the nitrogen source and supplied nitrogen at a concentration of 50 kg/ha. Sodium selenite (mineral/inorganic selenium) was used at a concentration of 8 g/ha.

### Treatments and Experimental Design:

Three hundred seeds were grown in individual plastic pots or cells containing equal quantity of soil (7.5 L) in order to obtain, at the end of the study, 100 g of biomass. The treatments T1 to T6 (see Table 1) were distributed randomly in lines, with each line comprising of all treatments. All the treatments were repeated ten times.

TABLE 1
Treatments

| | | Supplied | Supplied |
|---|---|---|---|
| Treat- | | selenium | nitrogen |
| ments | | concentration | concentration |
| T1 | untreated | 0 | 0 |
| T2 | ammonium sulfate (50 kg/ha) | 0 | 50 kg/ha |
| T3 | ammonium sulfate (50 kg/ha) + | 8 g/ha | 50 kg/ha |
| | sodium selenate (8 g/ha) | | |
| T4 | ammonium sulfate (50 kg/ha) + | 4.8 g/ha | 50 kg/ha |
| | selenium supplied by a | | |
| | selenium-enriched yeast | | |
| | (4.8 g/ha) | | |
| T5 | selenium supplied by a | 4.8 g/ha | 0 |
| | selenium-enriched yeast | | |
| | (4.8 g/ha) | | |
| T6 | sodium selenate (8 g/ha) | 8 g/ha | 0 |

The treatments T1 to T6 were applied (typically three weeks after seedlings), in a liquid form, directly in the soil surrounding the seeds. The treatments were mixed with water and the application rate was 1 L/m². Seeds were grown under controlled conditions for 35 days. Growth conditions were 20° C. under a 16 hour photoperiod. In order to measure the above-ground biomass, the plants were cut at the base and fresh weight was measured. Selenium content was determined in the aerial parts of the plants by atomic absorption spectroscopy while the content of nitrogen, phosphorus, potassium, sulfur and dry matter was measured using a plasma torche.

### Results:

The results are reported in Table 2.

TABLE 2
Effect of a selenium-enriched yeast in combination with ammonium
sulfate on the internal concentration of selenium in aerial parts of ray grass

| | Supplied | Supplied | Mean |
|---|---|---|---|
| | selenium | nitrogen | concentration |
| Treatments | concentration | concentration | of selenium (ppm) |
| T1: untreated | 0 | 0 | 0.157B* |
| T2: ammonium sulfate | 0 | 50 kg/ha | 0.166AB |
| T3: ammonium sulfate + | 8 g/ha | 50 kg/ha | 0.186A |
| sodium selenate | | | |
| T4: ammonium sulfate + | 4.8 g/ha | 50 kg/ha | 0.188A |
| selenium-enriched | | | |
| yeast | | | |
| T5: selenium-enriched | 4.8 g/ha | 0 | 0.175AB |
| yeast | | | |
| T6: sodium selenate | 8 g/ha | 0 | 0.184A |

*Means with the same letter are not significanty different from each other (Tukey-Kramer test, P > 0.05).

Table 2 shows the amount of assayed selenium in the aerial parts of plants according to the different treatments. The three treatments in which the dosage is the most important are the sodium selenate (or mineral/inorganic selenium) provided alone (T6), the sodium selenate in combination with a nitrogen source (T3) and the selenium-enriched yeast in combination with a nitrogen source (T4). These three treatments are significantly different from the untreated control at the 5% threshold. To a lesser extent, a selenium-enriched yeast intake (T5) also allows a selenium gain in plants. This treatment is significantly different from the untreated control at the 10% threshold.

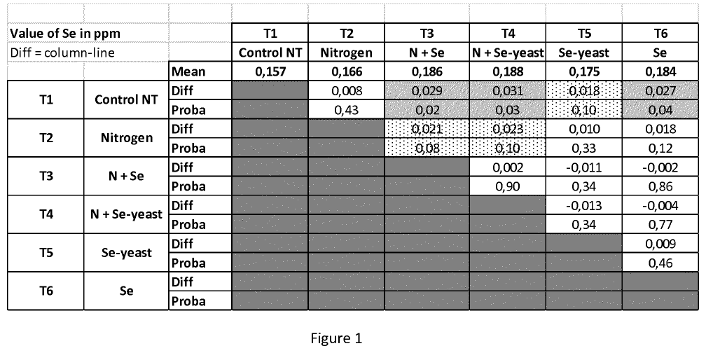

As indicated, a significant difference between the untreated control and the nitrogen source with mineral selenium and between the untreated control and the nitrogen supply with yeast enriched in selenium is observed. In addition, as shown in FIG. 1, both treatments T3 (sodium selenate in combination with a nitrogen source) and T4 (selenium-enriched yeast in combination with a nitrogen source) can be considered identical (probability of similarity of 90%). It is also observed that the treatment sodium selenate in combination with a nitrogen source (T3) and the sodium selenate (or mineral/inorganic selenium) provided alone (T6) gave the same level of selenium enrichment with or without a nitrogen source.

It has been demonstrated that the combination of a selenium-enriched yeast and at least one nitrogen source enables the use of relative lower amounts of selenium (4.8 g/ha of selenium metal) as compared with the amounts required to achieve the same effect with sodium selenate in combination with a nitrogen source (8 g/ha of selenium metal). This feature is particularly advantageous since any adverse side effects induced by the use of inorganic selenium are substantially reduced.

While the invention has been described in connection with specific embodiments thereof, it will be understood that the scope of the claims should not be limited by the preferred embodiments set forth in the examples, but should be given the broadest interpretation consistent with the description as a whole.

### REFERENCE

Winkel et al. 2015. Selenium Cycling Across Soil-Plant-Atmosphere Interfaces: A Critical Review. Nutrients: 7(6), 4199-4239.

Further aspects of the invention:

1. A method for increasing the selenium content of a plant comprising simultaneously, sequentially or separately inoculating a soil environment with an effective amount:
(a) of selenium supplied by a selenium-enriched yeast; and
(b) at least one nitrogen source;
in an (a)/(b) weight ratio of 1:20 to 1:50 000;
thereby producing selenium-enriched plants with an increased internal concentration of selenium in comparison to the selenium content of selenium-enriched plants treated with a selenium-enriched yeast alone.
2. The method of paragraph 1, wherein said selenium-enriched plants contain an internal concentration of selenium similar or higher than selenium-enriched plants produced when inorganic selenium are used alone or in combination with at least one nitrogen source.
3. The method of paragraph 2, wherein said amount of selenium supplied by said selenium-enriched yeast required for increasing the selenium content of said plant is at least 10%, 15%, 20%, 25%, 30%, 35%, 40%, 45%, 50%, 55%, 60%, 65%, 70% or 75% smaller than the amount required to achieve the same selenium content of said plant when inorganic selenium are used alone or in combination with at least one nitrogen source.
4. The method of any one of paragraphs 1 to 3, wherein said selenium-enriched yeast is an active selenium-enriched yeast, an inactivated selenium-enriched yeast, a selenium-enriched yeast extract, a selenium-enriched yeast autolysate, selenium-enriched yeast cell walls, selenium-enriched yeast derivatives or combinations thereof.
5. The method of paragraph 4, wherein said selenium-enriched yeast is an inactivated selenium-enriched yeast and/or selenium-enriched yeast derivatives.
6. The method of any one of paragraphs 1 to 5, wherein:
(a) the selenium-enriched yeast is a Saccharomyces; optionally wherein the yeast belongs to the species S. cerevisiae or S. cerevisiae var. boulardii; or
(b) the selenium-enriched yeast is a non-Saccharomyces yeast; optionally wherein the non-Saccharomyces yeast belongs to the genera Candida, Torula, Hanseniaspora, Hansenula, Kluyveromyces, Metschnikowia, Pichia, Starmerella, Torulaspora or mixture thereof.
7. The method of any one of paragraphs 1 to 6, wherein the amount of selenium supplied by the selenium-enriched yeast is between 500 to 10 000 ppm; preferably wherein said amount of selenium supplied by the selenium-enriched yeast is at least about 2000 ppm, 3000 ppm, 4000 ppm, 5000 ppm, 6000 ppm, 7000 ppm, 8000 ppm, 9000 ppm or 10 000 ppm.
8. The method of any one of paragraphs 1 to 7, wherein said at at least one nitrogen source is urea, liquid urea ammonium nitrate, ammonium anhydrous, calcium nitrate, potassium nitrate, ammonium sulfate, ammonium thiosulphate, ammonium phosphate, liquid ammonium polyphosphate, ammonium nitrate, or mixtures thereof.
9. The method of any one of paragraphs 1 to 8, wherein the (a)/(b) weight ratio is at least of about 1:20; 1:25; 1:50; 1:100; 1:150; 1:200; 1:250; 1:300; 1:350; 1:400; 1:450; 1:500; 1:550; 1:600; 1:650; 1:700; 1:750; 1:800; 1:850; 1:900; 1:950; 1:1000; 1:1250;

1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500; 1:10 000; 1:12 500; 1:15 000; 1:17 500; 1:20 000; 1:22 500 or 1:25 000.

10. The method of any one of paragraphs 1 to 9, wherein the selenium supplied by the selenium-enriched yeast is applied to the soil environment at a rate of about 0.05 to 20 g/ha, 0.1 to 20 g/ha, 0.5 to 20 g/ha, 1 to 15 g/ha, 1 to 10 g/ha, 2 to 10 g/ha or 2 to 5 g/ha.
11. A composition for increasing the selenium content of a plant comprising:
(a) a selenium-enriched yeast; and
(b) at least one nitrogen source
in an (a)/(b) weight ratio in the range of 1:20 to 1:50 000;
wherein said composition is effective to produce selenium-enriched plants with an increased internal concentration of selenium in comparison to the selenium content of selenium-enriched plants treated with a selenium-enriched yeast alone.
12. The composition of paragraph 11, wherein said selenium-enriched yeast is an active selenium-enriched yeast, an inactivated selenium-enriched yeast, a selenium-enriched yeast extract, a selenium-enriched yeast autolysate, selenium-enriched yeast cell walls, selenium-enriched yeast derivatives or combinations thereof.
13. The composition of paragraph 12, wherein said selenium-enriched yeast is an inactivated selenium-enriched yeast and/or selenium-enriched yeast derivatives.
14. The composition of any one of paragraphs 11 to 13, wherein:
(a) the selenium-enriched yeast is a Saccharomyces; optionally wherein the yeast belongs to the species S. cerevisiae or S. cerevisiae var. boulardii; or
(b) the selenium-enriched yeast is a non-Saccharomyces yeast; optionally wherein the non-Saccharomyces yeast belongs to the genera Candida, Torula, Hanseniaspora, Hansenula, Kluyveromyces, Metschnikowia, Pichia, Starmerella, Torulaspora or mixture thereof.
15. The composition of any one of paragraphs 11 to 14, wherein the amount of selenium supplied by the selenium-enriched yeast is between 500 to 10 000 ppm; preferably wherein said amount of selenium supplied by the selenium-enriched yeast is at least about 2000 ppm, 3000 ppm, 4000 ppm, 5000 ppm, 6000 ppm, 7000 ppm, 8000 ppm, 9000 ppm or 10 000 ppm.
16. The composition of any one of paragraphs 11 to 15, wherein said at at least one nitrogen source is urea, liquid urea ammonium nitrate, ammonium anhydrous, calcium nitrate, potassium nitrate, ammonium sulfate, ammonium thiosulphate, ammonium phosphate, liquid ammonium polyphosphate, ammonium nitrate, or mixtures thereof.
17. The composition of any one of paragraphs 11 to 16, wherein the (a)/(b) weight ratio is at least of about 1:20; 1:25; 1:50; 1:100; 1:150; 1:200; 1:250; 1:300; 1:350; 1:400; 1:450; 1:500; 1:550; 1:600; 1:650; 1:700; 1:750; 1:800; 1:850; 1:900; 1:950; 1:1000; 1:1250; 1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500; 1:10 000; 1:12 500; 1:15 000; 1:17 500; 1:20 000; 1:22 500 or 1:25 000.
18. The composition of any one of paragraphs 11 to 17, wherein the selenium supplied by the selenium-enriched yeast is applied to the soil environment at a rate of about 0.05 to 20 g/ha, 0.1 to 20 g/ha, 0.5 to 20 g/ha, 1 to 15 g/ha, 1 to 10 g/ha, 2 to 10 g/ha or 2 to 5 g/ha.

What is claimed is:

1. A method for increasing the selenium content of a plant comprising simultaneously, sequentially or separately inoculating a soil environment with an effective amount:
(a) of selenium supplied by a selenium-enriched yeast; and
(b) at least one nitrogen source;
in an (a)/(b) weight ratio of 1:1000 to 1:70 000;
thereby producing selenium-enriched plants with an increased internal concentration of selenium in comparison to the selenium content of selenium-enriched plants treated with a selenium-enriched yeast alone.

2. The method of claim 1, wherein said selenium-enriched plants contain an internal concentration of selenium similar or higher than selenium-enriched plants produced when inorganic selenium are used alone or in combination with at least one nitrogen source.

3. The method of claim 2, wherein said amount of selenium supplied by said selenium-enriched yeast required for increasing the selenium content of said plant is at least 10%, 15%, 20%, 25%, 30%, 35%, 40%, 45%, 50%, 55%, 60%, 65%, 70% or 75% smaller than the amount required to achieve the same selenium content of said plant when inorganic selenium are used alone or in combination with at least one nitrogen source.

4. The method of any one of claims 1 to 3, wherein said selenium-enriched yeast is an active selenium-enriched yeast, an inactivated selenium-enriched yeast, a selenium-enriched yeast extract, a selenium-enriched yeast autolysate, selenium-enriched yeast cell walls, selenium-enriched yeast derivatives or combinations thereof.

5. The method of claim 4, wherein said selenium-enriched yeast is an inactivated selenium-enriched yeast and/or selenium-enriched yeast derivatives.

6. The method of any one of claims 1 to 5, wherein:
(a) the selenium-enriched yeast is a Saccharomyces; optionally wherein the yeast belongs to the species S. cerevisiae or S. cerevisiae var. boulardii; or
(b) the selenium-enriched yeast is a non-Saccharomyces yeast; optionally wherein the non-Saccharomyces yeast belongs to the genera Candida, Torula, Hanseniaspora, Hansenula, Kluyveromyces, Metschnikowia, Pichia, Starmerella, Torulaspora or mixture thereof.

7. The method of any one of claims 1 to 6, wherein the amount of selenium supplied by the selenium-enriched yeast is between 500 to 10 000 ppm; preferably wherein said amount of selenium supplied by the selenium-enriched yeast is at least about 2000 ppm, 3000 ppm, 4000 ppm, 5000 ppm, 6000 ppm, 7000 ppm, 8000 ppm, 9000 ppm or 10 000 ppm.

8. The method of any one of claims 1 to 7, wherein said at at least one nitrogen source is urea, liquid urea ammonium nitrate, ammonium anhydrous, calcium nitrate, potassium nitrate, ammonium sulfate, ammonium thiosulphate, ammonium phosphate, liquid ammonium polyphosphate, ammonium nitrate, or mixtures thereof.

9. The method of any one of claims 1 to 8, wherein the (a)/(b) weight ratio is at least of about 1:1250; 1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500; 1:10 000; 1:10 500; 1:11 000; 1:11 500; 1:12 000; 1 to 12 500; 1:15 000; 1:17 500; 1:20 000; 1:22 500, 1:25 000, 1:30 000; 1:35 000; 1:40 000; or 1:50 000.

10. The method of any one of claims 1 to 9, wherein the (a)/(b) weight ratio is about 1:5000 to about 1:20 000.

11. The method of any one of claims 1 to 10, wherein the selenium supplied by the selenium-enriched yeast is applied to the soil environment at a rate of about 0.05 to 20 g/ha, 0.1 to 20 g/ha, 0.5 to 20 g/ha, 1 to 15 g/ha, 1 to 10 g/ha, 2 to 10 g/ha or 2 to 5 g/ha.

12. The method of any one of claims 1 to 11, wherein said inoculation is simultaneous.

13. The method according to any one of the preceding claims, wherein the inoculation of a soil environment is carried prior to establishment of a seed for said plant.

14. The method according to any one of the preceding claims, wherein the inoculation of a soil environment is carried out prior to growth of said plant.

15. The method according to claim 13 or 14, wherein the soil environment comprises seeds for said plant.

16. The method according to any one of the preceding claims, wherein said plant is a leguminous plant, a grass, a cereal, a vegetable, a fruit crop or a food crop.

17. The method according to claim 16, wherein said plant is an animal food crop, such as a forage crop, a cereal, maize, a leguminous plant, or an oil and/or protein-rich plant or vegetable crop.

18. A composition for increasing the selenium content of a plant comprising:
(a) selenium supplied by a selenium-enriched yeast; and
(b) at least one nitrogen source
in an (a)/(b) weight ratio in the range of 1:1000 to 1:70 000;
wherein said composition is effective to produce selenium-enriched plants with an increased internal concentration of selenium in comparison to the selenium content of selenium-enriched plants treated with a selenium-enriched yeast alone.

19. The composition of claim 18, wherein said selenium-enriched yeast is an active selenium-enriched yeast, an inactivated selenium-enriched yeast, a selenium-enriched yeast extract, a selenium-enriched yeast autolysate, selenium-enriched yeast cell walls, selenium-enriched yeast derivatives or combinations thereof.

20. The composition of claim 19, wherein said selenium-enriched yeast is an inactivated selenium-enriched yeast and/or selenium-enriched yeast derivatives.

21. The composition of any one of claims 18 to 20, wherein:
(a) the selenium-enriched yeast is a Saccharomyces; optionally wherein the yeast belongs to the species S. cerevisiae or S. cerevisiae var. boulardii; or
(b) the selenium-enriched yeast is a non-Saccharomyces yeast; optionally wherein the non-Saccharomyces yeast belongs to the genera Candida, Torula, Hanseniaspora, Hansenula, Kluyveromyces, Metschnikowia, Pichia, Starmerella, Torulaspora or mixture thereof.

22. The composition of any one of claims 18 to 21, wherein the amount of selenium supplied by the selenium-enriched yeast is between 500 to 10 000 ppm; preferably wherein said amount of selenium supplied by the selenium-enriched yeast is at least about 2000 ppm, 3000 ppm, 4000 ppm, 5000 ppm, 6000 ppm, 7000 ppm, 8000 ppm, 9000 ppm or 10 000 ppm.

23. The composition of any one of claims 18 to 22, wherein said at at least one nitrogen source is urea, liquid urea ammonium nitrate, ammonium anhydrous, calcium nitrate, potassium nitrate, ammonium sulfate, ammonium thiosulphate, ammonium phosphate, liquid ammonium polyphosphate, ammonium nitrate, or mixtures thereof.

24. The composition of any one of claims 18 to 23, wherein the (a)/(b) weight ratio is at least of about 1:1250; 1:1500; 1:1750; 1:2000; 1:2500; 1:3000; 1:3500; 1:4000; 1:4500; 1:5000; 1:5500; 1:6000; 1:6500; 1:7000; 1:7500; 1:8000; 1:8500; 1:9000; 1:9500; 1:10 000; 1:10 500; 1:11 000; 1:11 500; 1:12 000; 1:12 500; 1:15 000; 1:17 500; 1:20 000; 1:22 500; 1:25 000; 1:30 000; 1:35 000; 1:40 000; or 1:50 000.

25. The composition of any one of claims 18 to 24, wherein the (a)/(b) weight ratio is about 1:5000 to about 1:20 000.

26. The composition of any one of claims 18 to 25 wherein the selenium supplied by the selenium-enriched yeast is applied to the soil environment at a rate of about 0.05 to 20 g/ha, 0.1 to 20 g/ha, 0.5 to 20 g/ha, 1 to 15 g/ha, 1 to 10 g/ha, 2 to 10 g/ha or 2 to 5 g/ha.

27. A method of fertilising a soil environment comprising inoculating said soil environment with a composition as defined in any one of claims 18 to 25, or simultaneously, sequentially or separately inoculating a soil environment with an effective amount of (a) selenium supplied by a selenium-enriched yeast; and (b) at least one nitrogen source, in an (a)/(b) weight ratio of 1:1000 to 1:70 000; wherein said effective amount is capable of producing selenium-enriched plants with an increased internal concentration of selenium in comparison to the selenium content of selenium-enriched plants treated with a selenium-enriched yeast alone, optionally wherein said simultaneous, sequential or separate inoculation, said selenium-enriched yeast and/or said nitrogen source is as defined in any one of claims 2-17.

28. Use of at least one nitrogen source for increasing selenium uptake in a plant or seed from a selenium-enriched yeast.

29. Use according to claim 28 wherein (a) the selenium supplied by the selenium-enriched yeast; and (b) the at least one nitrogen source, in an (a)/(b) weight ratio of 1:1000 to 1:70 000.

30. Use according to claim 28 or 29, wherein said selenium-enriched yeast, said nitrogen source and/or said plant or seed are as defined in any one of claims 2-17.
